(19) United States
(12) Patent Application Publication
(10) Pub. No.: US 2008/0255008 A1
(43) Pub. Date: Oct. 16, 2008

(54) GELATION CONTROLLED FLUID FLOW IN A MICROSCALE DEVICE

(76) Inventors: Steven A. Hayes, Madison, WI (US); Ivar Meyvantsson, Madison, WI (US)

Correspondence Address: QUARLES & BRADY LLP, 33 E. MAIN ST, SUITE 900, P.O BOX 2113, MADISON, WI, 53701-2113, US

(21) Appl. No.: 12/099,871

(22) Filed: Apr. 9, 2008

Related U.S. Application Data
(60) Provisional application No. 60/923,606, filed on Apr. 16, 2007.

(51) Int. Cl. C40B 60/12; C40B 60/00; B05D 5/00

(52) U.S. Cl. 506/39; 506/33; 427/256

(57) ABSTRACT

A method of self regulating a process of manufacturing a biological device which includes the steps of: choosing a first material and a second material based on a correlation of a parameter of the second material with a parameter of the first material; and merging the first material with the second material where the correlation of the parameter of the second material with the parameter of the first material self regulates the merging step to provide a distinct patterning of the first material and the second material.

### CROSS-REFERENCE TO RELATED APPLICATIONS

This application claims the benefit of U.S. Provisional Application No. 60/923,606 filed Apr. 16, 2007 which is incorporated herein by reference in its entirety.

### FIELD OF THE INVENTION

The present invention relates to microscale devices and methods of use thereof, and, more particularly, to gelation controlled fluid flow in a microfluidic device and devices and methods derived therefrom.

### BACKGROUND OF THE INVENTION

It is not unusual for a new drug to take ten to twelve years to bring to market at a cost in the high hundreds of millions of dollars, and with an overall success rate is less than 20%. Further, many drugs fail in clinical trials after hundreds of millions of dollars have already been invested. This situation is obviously costly and undesirable, an possibly unsustainable, and pharmaceutical companies are constantly in need of technologies that improve their R&D capabilities. A major challenge is using living cells to model human disease in the highly miniaturized and automated format used for high throughput screening (HTS), a widely used process for winnowing drug candidates from large chemical libraries early in drug development, cellular assays being a component of such HTS. HTS lab directors consistently mention development of new HTS assays for the increasing number of drug targets as the worst bottleneck in early stage drug development (High Tech Business Decisions, 2005).

HTS assays are the key tools used in the early phase of drug discovery to identify molecules that disrupt a disease process. The process involves the testing of hundreds of thousands of potential drug molecules in a highly parallel, automated fashion for their interaction with model systems that mimic human disease. HTS is the foundation of drug discovery; the success of downstream development is critically dependent on the quality of the information it provides.

Because of the high number of individual tests performed in parallel, miniaturization is extremely important for preserving precious biological samples. Minimizing the number of manipulations required to perform an assay is critical for automation. One of the important ways that these miniaturization and automation goals have been achieved is by using multiwell plates, 96 and 384 well plates are most common, which can be thought of as an array of miniature test tubes used for doing thousands of experiments in parallel. In an HTS assay, each well typically contains a potential drug molecule, a biological component such as a protein or cells, and detection reagents that report on their interaction. Multiwell plates are the paradigm for HTS assays; much of the automated liquid dispensing, robotics and detection instrumentation used in pharmaceutical drug discovery is aligned with standard plate dimensions and well spacing. Hundreds or even thousands of plates are often used for a single screening campaign that may take a few days to several weeks to complete. HTS assays are used to test large numbers of potential drug targets are for their interaction with cells or proteins used to model a disease. In a typical screen, 500,000 molecules are tested, resulting in about 250 interactions or “hits”.

Unfortunately, the use of multiwell plates for cellular assays is imposing limits on their miniaturization and automation, and on the ability to reconstruct the microenvironment that cells inhabit in the body. The miniaturization and automation issues are already recognized as significant technical hurdles hampering the use of cellular assays for HTS, and the microenvironment issue is emerging as the relationship between cellular context and function becomes better defined for cancer and other diseases. All three problems are mentioned among the top ten challenges faced by HTS in a recent review in Drug Discovery and Development (Boguslavsky, 2004).

Common well densities for multiwell plates are 96, 384 and 1536 wells per plate; the typical corresponding assay volumes used (total volume per well) for these well densities are 50-200 microliters (μl), 20-50 μl, and 2-10 μl, respectively; and the required liquid dispensed volumes are microliters, microliter-nanoliter, and nanoliter, respectively. Consequently, 96 well plates are very commonly used for cellular assays whereas 384 well plates are commonly used with some problems, and 1536 well plates are rarely used. To better understand these limitations consider a 384 well plate with an assay volume of 10-20 μl. Other components, such as potential drug molecules or detection reagents, are then added at 1/10 to 1/100 of the total assay volume, which requires the dispensing of vanishingly small volumes.

Nanoliter liquid dispensing equipment is very complex and requires a major capital investment. Moreover, even with the best equipment, the well to well variability in dispensed volumes is significant. For this reason, and others explained below, the vast majority of cellular assays are done in 96 or 384 well plates, and further miniaturization is viewed as impractical.

The inability to miniaturize sufficiently means that some very useful types of cells with tremendous potential as disease models, including stem cells and primary cell lines, cannot currently be used in HTS because they are not available in sufficient quantities. Also, the well-to-well variability inherent in nanoliter dispensing means that a higher number of replicate wells are required to give statistically meaningful results; this increases the need for cells and other valuable assay reagents by an additional factor of 2-3.

Automation limits the types of assays that can be done in multiwell plates. Cells are generally grown as loosely attached monolayers on the bottom of a well. Culture media containing the highly specialized ingredients required for cell survival is the main liquid component. A very common manipulation when using multiwell plates, either for normal cell maintenance or as part of an assay protocol, is “plate washing”: sucking out old media and replacing it with new media. Because it is not possible to remove all of the media without disturbing the cells, three or four cycles of aspiration and dispensing are required for some very common types of assays such as immunoassays. The automation of plate washing for hundreds or thousands of plates is extremely cumbersome and it is generally avoided for even moderate sized screens. Moreover, plate washing is difficult to miniaturize below the 384 well plate format because of problems with bubbles and damage to cells; there is currently only one commercial 1536 well plate washer available.

Increasingly, HTS assays rely on cells that are grown (“cultured”) outside the body as the biological component. Disease models based on living cells can provide more information about how a potential drug molecule works than assays based on simpler biological components, such as isolated proteins. Moreover, it is generally believed that the use of cellular assays will provide information that is more predictive of how humans will respond to a drug than simpler assays. This is a critical need given the high rate of clinical attrition and the costs it imposes on the pharmaceutical industry.

In live tissue, different types of cells carry out specialized roles within a complex, three-dimensional architecture. Many cellular processes, including those linked to disease pathologies, are replicated poorly or not at all in multiwell plates. This is partly because their relatively large volume rapidly dilutes molecular signals between cells. An analogy is two people on opposite sides of a lake attempting to communicate by making waves with their hands. An added limitation is the inability to mimic tissue structure, which requires multiple cell types in defined locations. All control of cell position or behavior is lost once they are added to a well. For these reasons cellular HTS assays often poorly predict drug action in humans, the very task they are depended upon to perform.

These inherent limitations of multiwell plates decrease the types of cellular assays that can be used in known HTS and the ability to miniaturize them. This means that important information on how potential drug molecules affect cellular function, information that could help prevent clinical failures, is being overlooked.

Another limitation to the multiwell plates and other known HTS techniques is that they do not provide a way of producing a test sample, such as a tissue model, which has a predictable pattern and distinct interface. Yet another limitation to the multiwell plates and other known HTS techniques is that they do not provide a method of detection or readout which is indicative of a test sample reacting with a drug or reagent, for example.

What is needed in the art is a device and method which is suitable for use in HTS assays, which can be implemented cost effectively in a high density and automated format, which uses a minimum of reagent, cellular, biological, protein and other test materials, which provides a way of producing a test sample, such as a tissue model, and which has a predictable pattern and distinct interface. Additionally desired is a method of detection or readout which is indicative of a test sample changing status, for example.

### SUMMARY OF THE INVENTION

The present invention provides a microscale device that has unmatched advantages for miniaturization and automation of cellular assays. Unlike other microfluidic platforms that require the purchase of expensive, specialized equipment, the microscale device according to the present invention can be a single use, plastic device that can seamlessly integrate with automated liquid dispensing and detection instruments commonly used in HTS laboratories. The microscale device and other devices and methods provided by the present invention enable at least ten-fold improvements in key HTS metrics, allowing more screens to be run in less time and with lower costs. Importantly, the present invention significantly improves the quality of information used to select drug candidates for further development, thereby lowering the risk of costly clinical failures. However, the application of the present invention is not exclusively drug discovery, but can also be applied in the point of care diagnostics, bio-defense, biochemical, agricultural, immunology, molecular biology, molecular diagnostics, quality control, tissue culture, and synthetic chemistry/materials development, among others.

In one embodiment, the microscale device of the present invention advantageously uses gelatinous material, which can exist in a liquid form and transition to a more solid gelatinous form, and which can be weak enough that it's structure can be deformed or destroyed given enough pressure on the gelatinous material. This pressure can be referred to as the degradation pressure.

The present invention can use a variety of substances which can exist in both liquid and gelatinous form. Liquid-gel transition can occur in response to a variety of factors including temperature, ion concentration, pH and ultraviolet light and may be either reversible or irreversible. Numerous biochemical processes of interest involve, or can be quantified by, the degradation of gelatinous material.

In one embodiment, the microscale device of the present invention advantageously uses gelatinous materials in a microfluidic structure to form parallel regions of fluid in the microfluidic structure. These parallel regions of fluid in the microfluidic structure can be achieved by separate simultaneous laminar flow of two or more gelatinous materials in the microfluidic structure, and/or the gelatinous material(s) along with other fluids. Laminar flow is produced by exerting equal gentle pressure on two or more fluid reservoirs that are connected to inputs that merge to a single main channel where the streams originating from each reservoir merge and flow as one without transverse convection. A parameter, such as viscosity, of the two or more fluids can be correlated, or more specifically matched, to further facilitate the formation of the separate regions. However, it is conceivable to achieve separate parallel regions of fluid by adjusting other parameters such as the geometry of the input channels of the microfluidic device, etc.

In the past, and due to the backpressure at the reservoirs, it is challenging to induce liquid-gel transition of select strips of a laminar stream without deforming or destroying it in the process. In known techniques, careful control of pressure values and timing is necessary to achieve a stable gelatinous layer (compare procedure described by Kim, Yeon and Park, Biomed Microdevices (2007) 9:25-34), if at all possible, and such elaborate controls are not amenable to automation. Further, vibration and other extraneous inputs can destroy the individual gelatinous layers, and the more complex a setup the more opportunity for deleterious extraneous inputs.

In one embodiment, the present invention advantageously overcomes the limitations of known methods by employing a passive pumping technique along with novel multiple input microfluidic devices arranged in a MultiConduit Array™ (MCA). The passive pumping technique produces a gentle pressure head across the fluids which allows liquid-gel transition of select strips of a laminar stream without deforming or destroying it in the process. In other words, the gentle pressure head is less than the degradation pressure.

The combination of a gentle pressure head and MCA overcomes the limitations of multiwell plates, and other known methods, in an elegant way. Rather than using open wells, the MCA is an array of microscale conduits with ports at each end for introduction and overflow of liquid. The size and conduit spacing are compatible with existing HTS liquid handling and detection instrumentation. The passive pumping technology can allow complete replacement of the liquid in a conduit by simply adding a single drop, or multiple drops, at the addition port. More complete disclosure of passive pumping is disclosed in U.S. Pat. Nos. 7,189,581 and 7,189,580, and U.S. Patent Application No. 2006/0263241, all incorporated by reference, as if fully set forth herein. Passive pumping harnesses the same forces (i.e. surface tension) present in droplets to provide the forces to move fluid from the inlet port to the outlet port of the microconduit without the need of any mechanical pump. Thus, the present invention can be integrated seamlessly into existing HTS work flows without additional capital investment. Because it works by complete displacement of liquid in a very small conduit rather than repeated addition and removal of liquid from a much larger well, the present invention and particularly the MCA: allows miniaturization of assay volumes to less than 1/10 of those practical with multiwell plates; facilitates assay automation by eliminating many of the liquid handling steps required using multiwell plates, and enables more accurate replication of biologically relevant cellular microenvironments.

Because the present invention can operate by liquid displacement rather than repeated removal and addition of liquid, complete replacement of the media can be achieved by adding a single drop at the addition port. The washing occurs as the old media is displaced from the conduit without the need for separate plate washing equipment. The elimination of cumbersome plate washing with the present invention simplifies automation of many assays, decreasing overall screening timeliness. Moreover, it allows the use of many types of assays that are not currently practical for HTS, thus increasing the quantity and quality of information used to make decisions on advancing drug candidates into clinical trials.

The microscale device according to the present invention provides a more hospitable microenvironment for cells, allowing more faithful reproduction of cell functions and communication important in disease pathology. In addition, through design modifications of the MCA device and other parameters according to the present invention, reconstruction of more physiological tissue surrogates that replicate important disease processes is possible. These include positioning of two or more cell types in adjacent layers to allow signaling between them and reconstruction of three dimensional tissue architecture. Such realistic cellular formats, and ways to probe them more effectively, are made possible by the precise liquid flow control according to the present invention which is possible at the microscale; they are not possible in a well format or by other known methods.

The microscale device according to the present invention provides HTS laboratories with an immediate solution to very basic problems with miniaturization and automation of cellular assays, allowing more screens to be run in less time at a lower cost. Most importantly, by enabling the use of cellular assays that are more predictive of human responses, the present invention accelerates the discovery of more effective disease therapies and reduce the number of costly clinical failures.

Cells can be grown in a MCA device fabricated from an elastomeric polymer; or from plastic, for example. The present invention can provides a microfluidic device with multiple channels used to deliver a plurality of different cell populations in adjacent locations. This type of cell positioning allows the use of HTS assays that involve signaling between two different cell types; it is not be possible in a well format. Further, the method according to the present invention can include a method of readout, detection and/or monitoring which can indicate quantitative performance information and/or status change in the biological matter or cells.

More particularly MCA devices according to the present invention can be fabricated from polydimethylsilane, a biologically inert elastomeric polymer, or from clear plastic (polystyrene), or other materials. In one embodiment, a process called “hot embossing” is used, which molds for this process are relatively simple and inexpensive to make, enabling rapid prototyping of different designs with production runs of 50-100 hundred devices. Larger production run of a MCA device according to the present invention can be performed using injection molding.

Replacing the liquid in a well requires 3-4 cycles of liquid removal and addition. In some instances the liquid in a conduit of the MCA may be replaced with a single addition, or in general, may be replaced in fewer additions than the number of cycles of liquid removal and addition required of wells.

Some key performance advantages of some of the embodiments of the present invention include: as much as a ten-fold miniaturization, or greater, of cell-based assays, simplification of automation by elimination of cumbersome wash steps, reduction of variability in dispensed volumes and test compound concentrations, and more predictive assays by improving cellular microenvironment

The radical departure of the present invention's microfluidics platform from the complex plumbing required for known microfluidic platforms (see Kim et al., ibid), where delivery and removal of liquid to channels is typically achieved using a complex network of tubing, distinguishes the embodiments of the present invention incorporating passive pumping into an entirely different category. Some other benefits of some of the embodiments of the present invention over known methods can include one step media changes, eliminating wash steps, improved dispensing precision, and ultra-miniaturization which provides more tests per tray and lower utilization of scarce reagent and tissue material, and better replication of cellular environments.

Though the potential for miniaturization and improved cell microenvironment possible using microfluidics has been appreciated for some time, the requirement for expensive instrumentation associated with known methods that does not integrate with existing HTS infrastructure has prevented its widespread adoption in drug discovery (Bhadriraju and Chen, 2002). The compatibility of the present invention with liquid handling equipment used in virtually every HTS laboratory overcomes these roadblocks.

Other advantages of some of the embodiments of the present invention include low reagent consumption, distinct interface between gel layers to better approximate tissue layers, predictable patterning of gels, and suitability to high throughput screening applications.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings.

FIG. 1 is a fragmentary perspective view of an embodiment of an automated high throughput screening system including a multichannel pipettor, and a multiconduit array of mircrofluidic devices according to the present invention, with the dispensing head of the multichannel pipettor in an up position.

FIG. 2 is a fragmentary perspective view of the embodiment of an automated high throughput screening system of FIG. 1, with the head of the multichannel pipettor in a downward dispensing position.

FIG. 3 is a detailed perspective view of an individual microfluidic device with initial fluid in the channels, and with the dispensing head of the multichannel pipettor dispensing input droplets.

FIG. 4 is a partly cross-sectional view taken along section line 4-4 in FIG. 3;

FIGS. 5A-5E are a series of cross-sectional views similar to FIG. 4 and illustrating the propagation of a fluid input in a channel through passive pumping.

FIG. 6 is a top view of an individual microfluidic device of FIG. 3, illustrating the propagation of four fluid inputs through passive pumping, and showing the distinct patterning of inputs with distinct interfaces.

FIG. 7 is a top view of the individual microfluidic device of FIG. 6, with the fluid propagation complete and a reconstituted tissue device in the center channel.

FIG. 8 is a top view of the individual microfluidic device of FIG. 7, with reagent drops added to the inputs of the outer channels and propagation beginning therethrough, and readout or detection drops added to the inputs of the inner gel channels.

FIG. 9 is a top view of the individual microfluidic device of FIG. 8, with the reagent drops having completed propagation in the outer channels, and the readout or detection drops in a standby mode waiting a change of status of the inner gel channels.

FIG. 10 is a top view of the individual microfluidic device of FIG. 9, now with one of the readout or detection drops being absorbed by the corresponding gel channel and indicating a change of status of that channel.

FIG. 11 is a top view of the individual microfluidic device of FIG. 7, with the outer channels evacuated.

FIG. 12 is a top view of an exemplary embodiment of another individual microfluidic device of according to the present invention, having two inputs and a single output.

FIG. 13 is a top view of an exemplary embodiment of another individual microfluidic device of according to the present invention, having five inputs and a five outputs.

FIG. 14 is a top view of another embodiment of an individual microfluidic device of according to the present invention, where the readout channels are crosswise from the gel and/or reagent channel.

FIG. 15 is a top view of the individual microfluidic device of FIG. 14, where the lower readout channel is indicating a change of status of the gel and/or reagent channel.

FIG. 16 is a cross-sectional view similar to FIG. 4, and illustrating an alternative pumping mechanism according to the present invention, which is shown as a water column, or other fluid column.

FIG. 17 is a perspective view of an individual well of a multiwell plate versus a cross-sectional view of a channel of microfluidic device according to the present invention, particularly illustrating the volume differences in the well (10-40 μl) and the microfluidic channel (1 μl), and also the lack of patterning and interfaces in the well device.

FIG. 18 is a top view and a perspective view of a specific microfluidic device according to the present invention, which was used to produce at least some of the test results of FIGS. 19-22.

FIG. 19 shows the results from deposition of two cell layers in matrigel using passive pumping. Green-red overlay image shows clear deposition of two adjacent cell layers. White lines represent boundaries of the device.

FIG. 20 shows that laminar flow can be used to create an open aqueous channel for reagent delivery. Inverted colloidal crystal (ICC) capability was added to the 3D coculture device. MCF 10A cells pumped adjacent to PEG continue to grow normally at day 4.

FIG. 21 shows interfaces between IrECM/cells and PEG/buffer (p/s RTD).

FIG. 22 shows passive pumping red beads in IrECM next to 25% PEG leads to open channels on both sides.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE PREFERRED EMBODIMENT

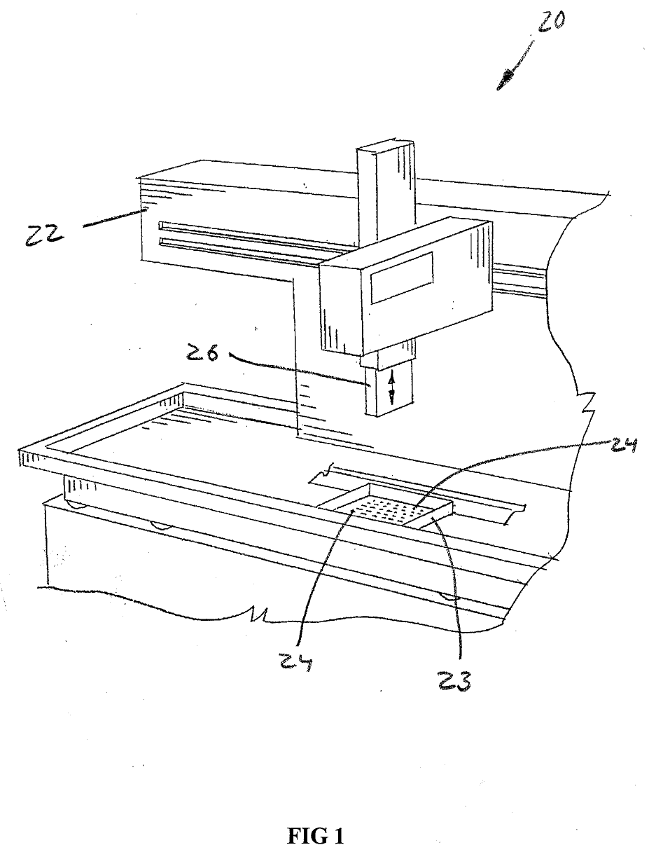

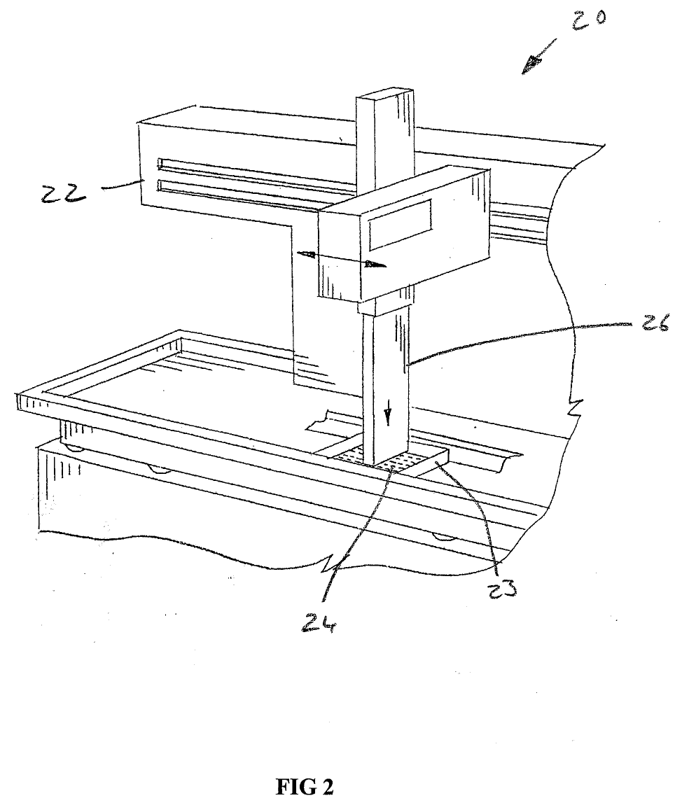

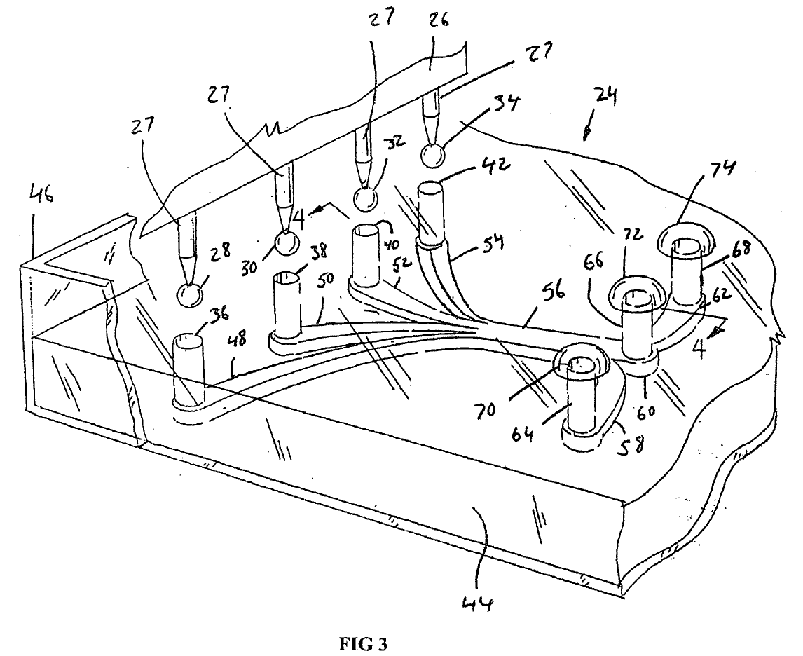

Referring now to the drawings, and more particularly to FIGS. 1 and 2, there is shown an automated high throughput screening system 20 which generally includes a multichannel pipettor 22, and a multiconduit array (MCA) 23 of mircrofluidic devices 24 according to the present invention, with the multichannel pipettor 22 in an up position. Multichannel pipettor 22 can be as manufactured by Beckman Coulter, or be one of many other multichannel pipettors. FIG. 2 illustrates the head 26 of multichannel pipettor 22 in a down position where individual pipettes 27 can deposit input droplets 28, 30, 32 and 34 (FIG. 3) into corresponding channel inlets 36, 38, 40 and 42 of one of the microfluidic devices 24 of multiconduit array 23.

More particularly, MCA 23 according to the present invention can be fabricated as a thin layer 44 of polydimethylsilane, a biologically inert elastomeric polymer, and with a tray 46 of clear plastic (polystyrene), or other materials. In one embodiment, a process called “hot embossing” is used to fabricate mircrofluidic devices 24 into thin layer or substrate 44 which is then placed in tray 46 which forms a boundary for each mircrofluidic devices 24. Molds for this process are relatively simple and inexpensive to make, enabling rapid prototyping of different designs with production runs of 50-100 hundred devices. Larger (or other) production runs of MCA device 22 according to the present invention can be performed using injection molding, micromachining with lasers or other machine tools, and other techniques. Tray 46 can have 96, 384 or 1536 mircrofluidic devices 24, or differing amounts (greater, less or in between) as dictated by the application.

A single microfluidic device 24 can include a plurality of channel inlets 36, 38, 40, and 42 in fluid communication with corresponding input channels 48, 50, 52 and 54. Input channels 48, 50, 52 and 54 open or merge into main channel 56. Channel 56 is in fluid communication with at least one output channel 58, 60 and 62, and corresponding outlets 64, 66 and 68.

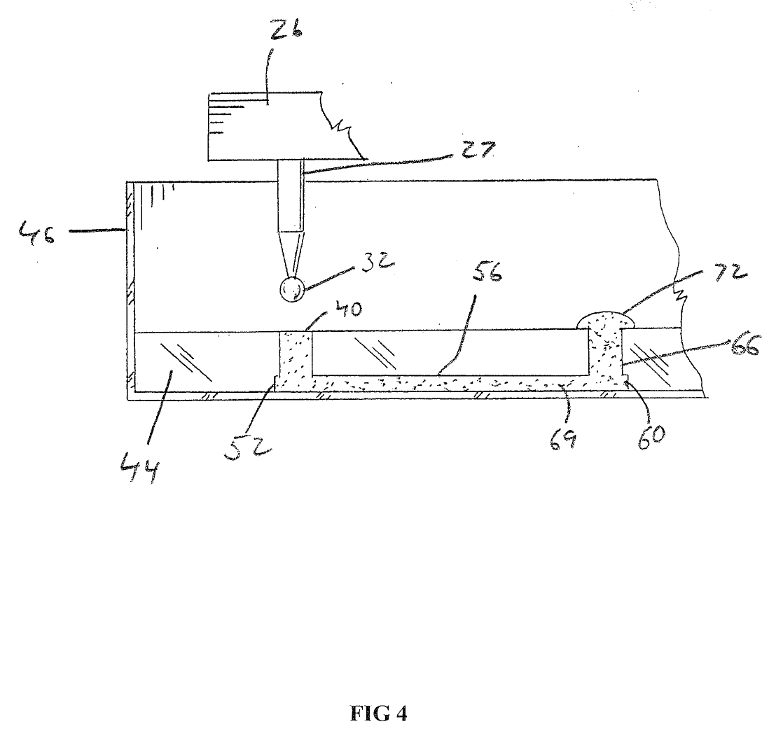

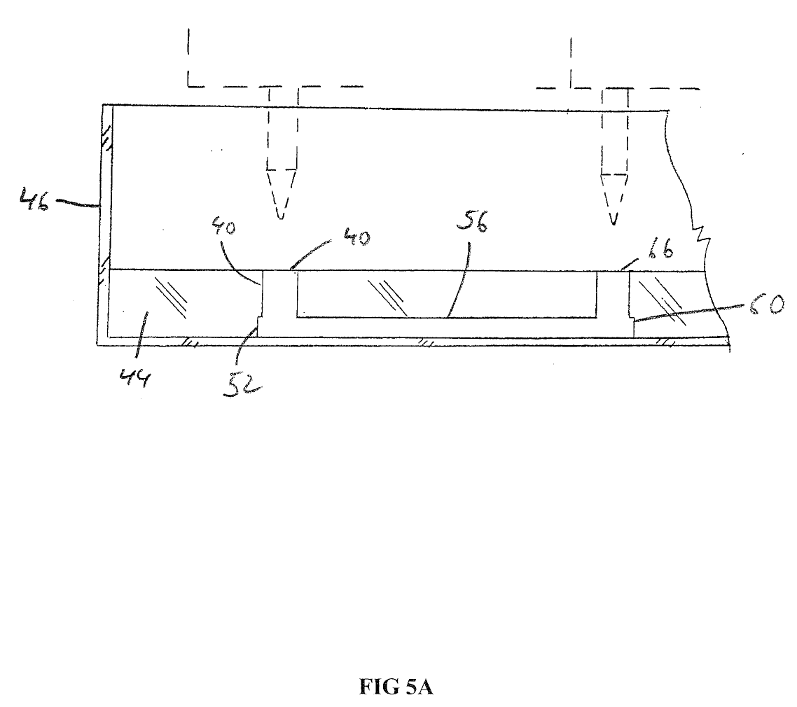

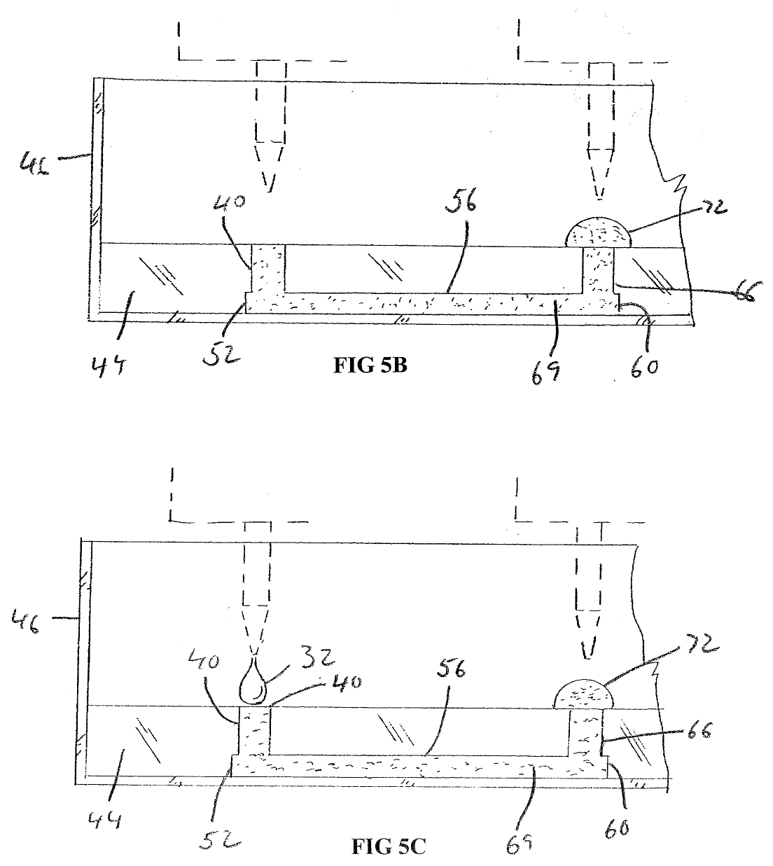

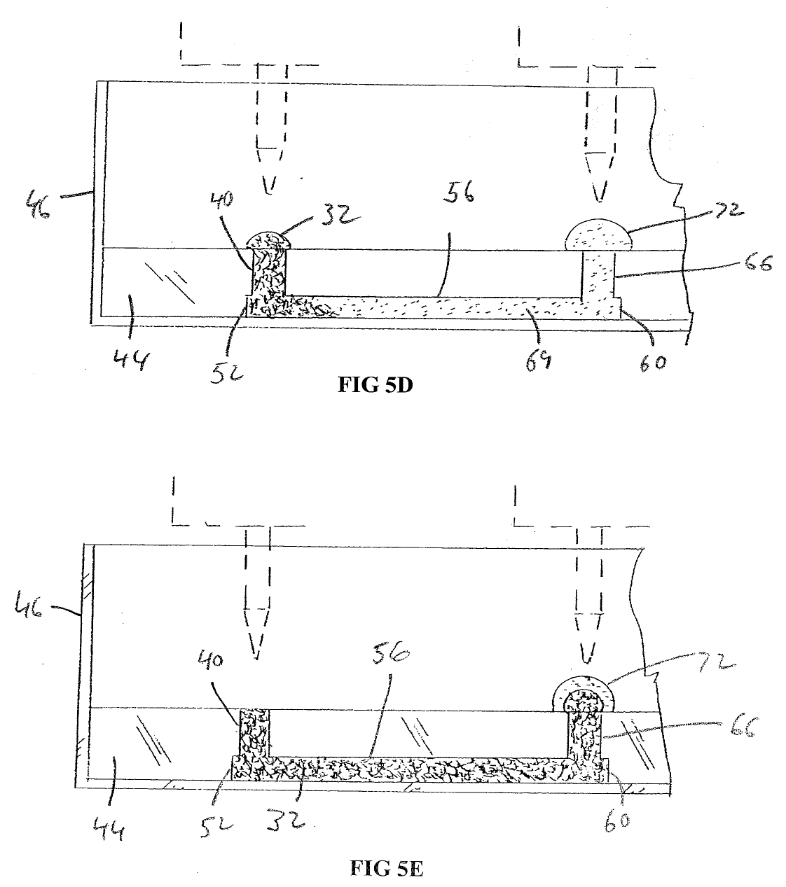

In the method according to the present invention microfluidic device 24 can be filled with an initial fluid 69, such as an aqueous fluid, with outlet drops 70, 72, 74. As input droplets 28, 30, 32 and 34 are applied to corresponding channel inlets 36, 38, 40, and 42, the smaller size of droplets 28, 30, 32 and 34 relative to outlet drops 70, 72, 74, through a process of passive pumping, described more fully in U.S. Pat. Nos. 7,189,581 and 7,189,580, and U.S. Patent Application No. 2006/0263241 all incorporated by reference as if fully set forth herein, creates a positive pressure differential or head between corresponding inlets and outlets of device 24 which starts a migration or propagation of respective materials from input droplets 28, 30, 32 and 34 into respective input channels 48, 50, 52 and 54, and main channel 56 as shown particularly in FIGS. 4-6. By employing a weak pressure gradient (such as with passive pumping) where the gentle pressure head is below the degradation pressure of the gel, the flow is autonomously cut off by the gel itself simultaneous with its formation. The pressure head, in the case of passive pumping can be calculated from equations 1-2 in the U.S. Pat. No. 7,189,581 patent, for example, knowing the surface free energy of the liquid and the size and shape of the corresponding drops. The degradation pressure of the gel, can vary from gel to gel, and can be determined experimentally by observing at what differential pressure head the gelatinous material is weak enough that it's structure can be deformed or destroyed, or in other words, where streams originating from each reservoir merge with transverse convection, i.e. mixing, the distinct interface breaks down. The degradation pressure may be a function of temperature, humidity, and other experimental variables, and may also be calculable as it may be a function of the surface tension of the gel, for example, if the gentle pressure head sufficiently exceeds the surface tension of the gel, degradation may occur. Further, the degradation pressure may also be a function of the relative physical parameters of adjoining liquid flows, or other physical parameters.

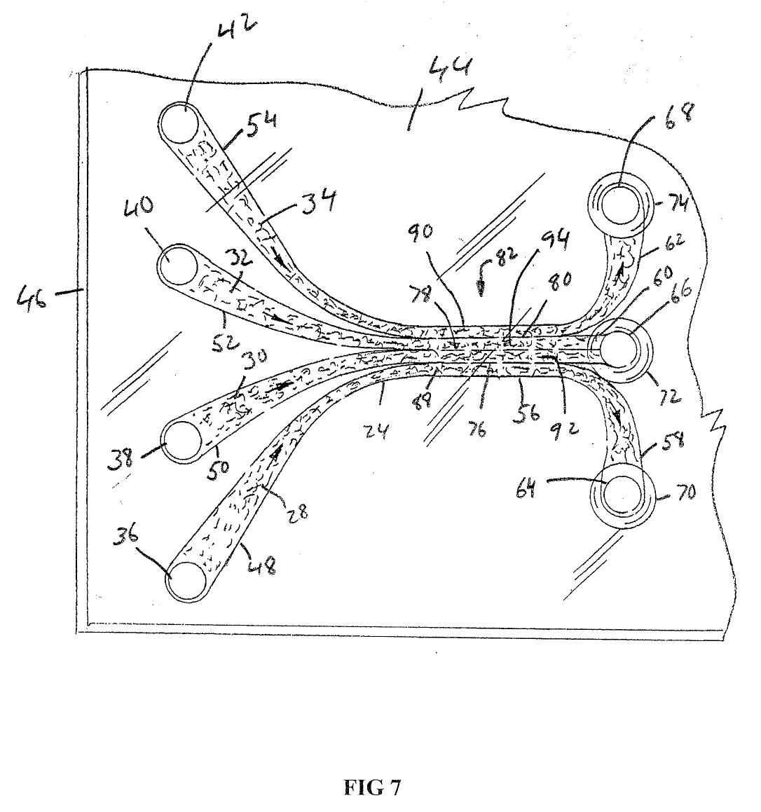

In one embodiment, the input droplets 30 and 32 are a gelatin material such as Matrigel™, collagen, a meshwork of protein and/or a combination thereof, or other known gelatin materials, with biological (cells, DNA, stem cells, proteins, etc.) material suspended therein, and the material in input droplets 28 and 34 can be polyethylene glycol (PEG). For example, in one form Matrigel™ matrix is a solubulized basement membrane preparation extracted from EHS mouse sarcoma, a tumor rich in ECM proteins. Major components can include laminin, followed by collagen IV, heparan sulfate proteoglycans, and entactin 1. At room temperature, the Matrigel™ matrix can polymerize to produce biologically active matrix material resembling the mammalian cellular basement membrane. Cells can behave as they do in vivo when they are cultured on the Matrigel™ matrix, as it provides a physiologically relevant environment for studies of cell morphology, biochemical function, migration or invasion, and gene expression. The gel/cell combination material of input droplets 30 and 32 are generally stored cool wherein they remain in a liquid state, and when they warm to a predetermined temperature, the materials change phase into a “solid” gel. In the method according to the present invention, the materials of PEG input droplets 28 and 34, and of gel input droplets 30 and 32 are selected such that there is a matching of viscosity between of PEG input droplets 28 and 34, and of gel input droplets 30 and 32 at the conditions of droplet application to respective channel inputs 36, 38, 40, and 42. The novel combination, according to the present invention, of matching or correlating material parameters (viscosity) of the different materials with passive pumping of the same materials in a microfluidic device, creates a predictable patterning of the materials in the main channel 56 (FIG. 7), and in the example shown a layered device, with distinct interfaces 76, 78 and 80

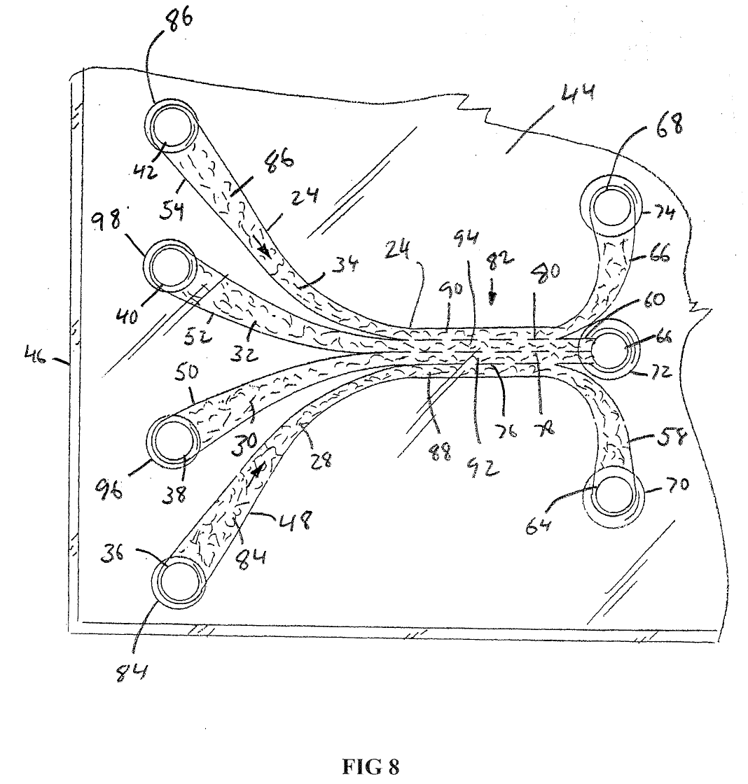

In FIG. 7, the reconstituted tissue device 82, with predictable patterning and distinct interfaces 76, 78, 80, is fully developed in main channel 56. Further, the gel materials in input channels 50 and 52, have changed phase from liquid to a “solid” gel. In FIG. 8, reagent, or other drug or test material, input drops 84, 86 can be applied to respective channel inputs 36, 42. The new material, using the passive pumping technique, expels the PEG in input channels 48 and 54, and also in the corresponding outer layers 88, 90 of the reconstituted tissue device 82 in main channel 56. When the reagent drops 84, 86 fully constitute outer layers 88, 90 of the reconstituted tissue device 82, then testing proceeds to determine interaction between reagent drops 84, 86 and gel material and associated biological constituents 30, 32 in respective inner layers 92, 94 of reconstituted tissue device 82.

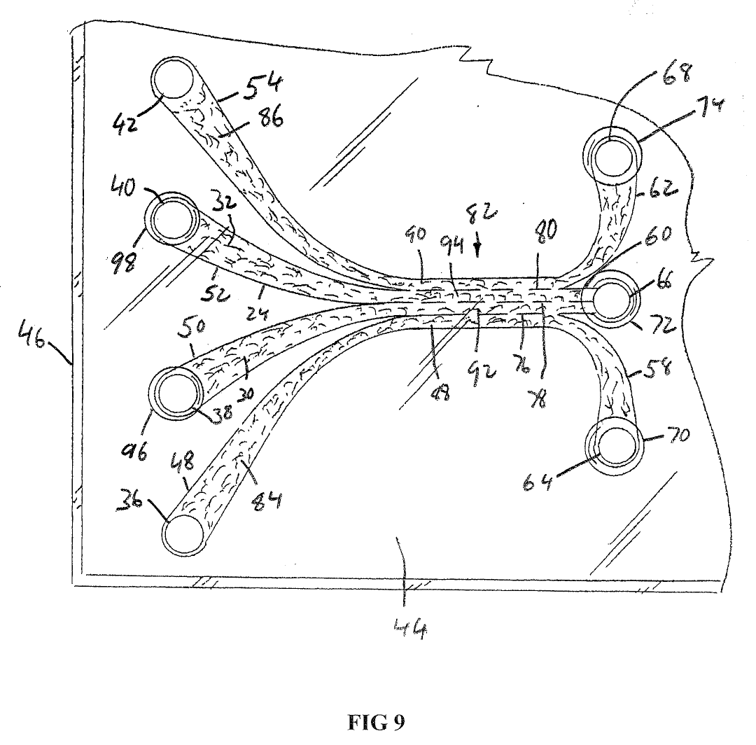

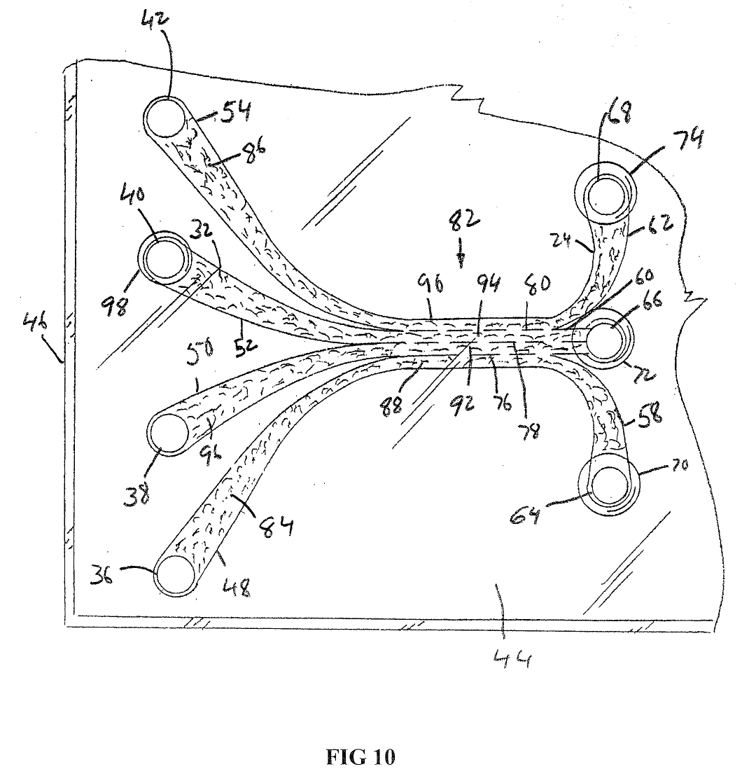

Another aspect of the present invention provides readout or detection drops 96, 98 (FIGS. 8 and 9) on channel inputs 38, 40. By sustaining a weak pressure gradient where the backpressure is below the degradation pressure of the gel, degradation of the gel can be detected via the occurrence of flow. In other words, a change, or no change, in the gel material in inner layers 92, 94 can be detected by the absence, or presence, respectively, of the readout drop(s), FIG. 10 illustrating the readout drop 96 being absorbed by the corresponding material in device 82 (FIG. 10). This method according to the present invention advantageously provides a simple and direct method of determining or monitoring test conditions and results.

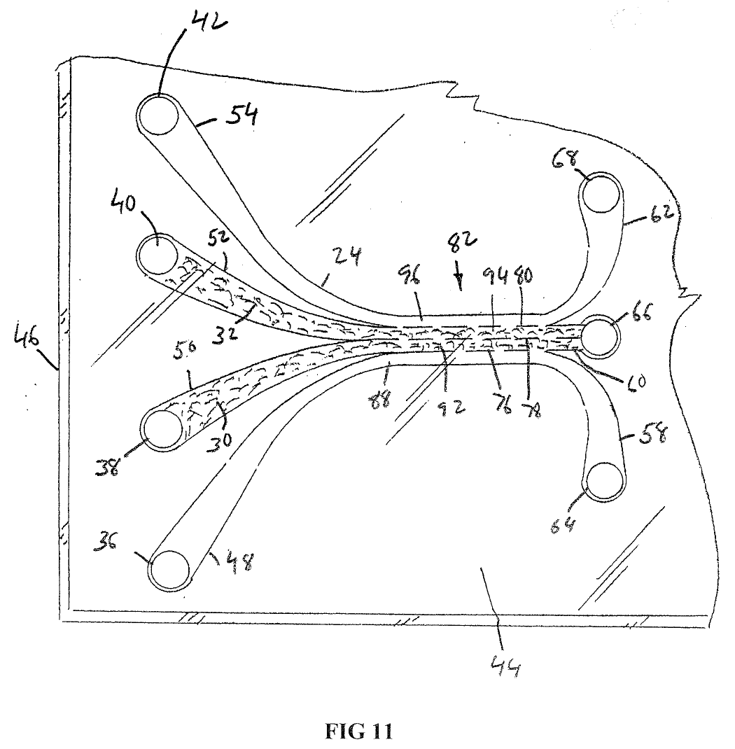

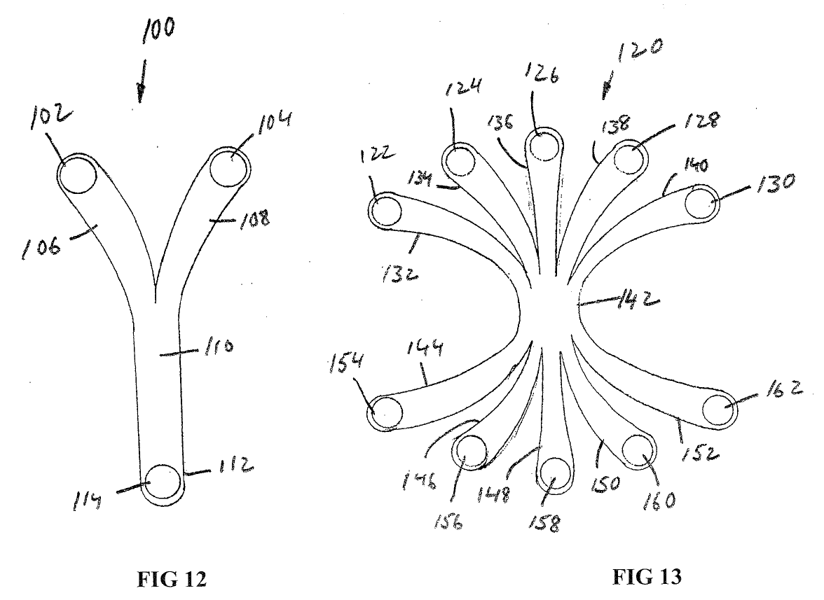

FIG. 11 illustrates an embodiment of reconstituted tissue device 82 wherein input channels 48 and 54, and corresponding outer layers 88, 90, have been evacuated creating open channels for drug or other reagent delivery. Further, the multiconduit array 23 according to the present invention can use a variety of mircrofluidic devices, some of which are illustrated in FIGS. 12 and 13. FIG. 12 illustrates microfluidic device 100 which can include a plurality of channel inlets 102 and 104 in fluid communication with corresponding input channels 106 and 108. Input channels 106 and 108 open or merge into main channel 110. Channel 110 is in fluid communication with at least one output channel 112 and corresponding outlet 114. This device is suitable for creating a reconstituted tissue device with a gel layer and an open aqueous channel, for example. FIG. 13 illustrates microfluidic device 120 which can include a plurality of channel inlets 122, 124, 126, 128 and 130 in fluid communication with corresponding input channels 132, 134, 136, 138 and 140. Input channels 132, 134, 136, 138 and 140 open or merge into main channel 142. Channel 142 is in fluid communication with at least one output channel 144, 146, 148, 150 and 152, and corresponding outlets 154, 156, 158, 160 and 162. This device is suitable for creating a reconstituted tissue device with adjacent gel layers, an open aqueous channel, and another gel layer and an open aqueous channel, for example; or two gel layers each layered in between two open channels, for another example. At least some of the other characteristics of devices 100 and 120 can be as previously described. The present invention can include as many channels as are required by different applications, as can the layer combinations vary widely. In general, a microfluidic device according to the present invention allows the liquids from the inputs to progress in a self regulating manner, with minimum or no mixing to create a predictable pattern and distinct interfaces, such as may be the case with laminar flow and/or when the surface tension of the propagating liquids are not interrupted, for example. Known methods have included unsuitable pumping mechanisms which disturb the flow causing mixing and unpredictable patterns. The known methods also include complex tubing which are not suitable for highly automated processes.

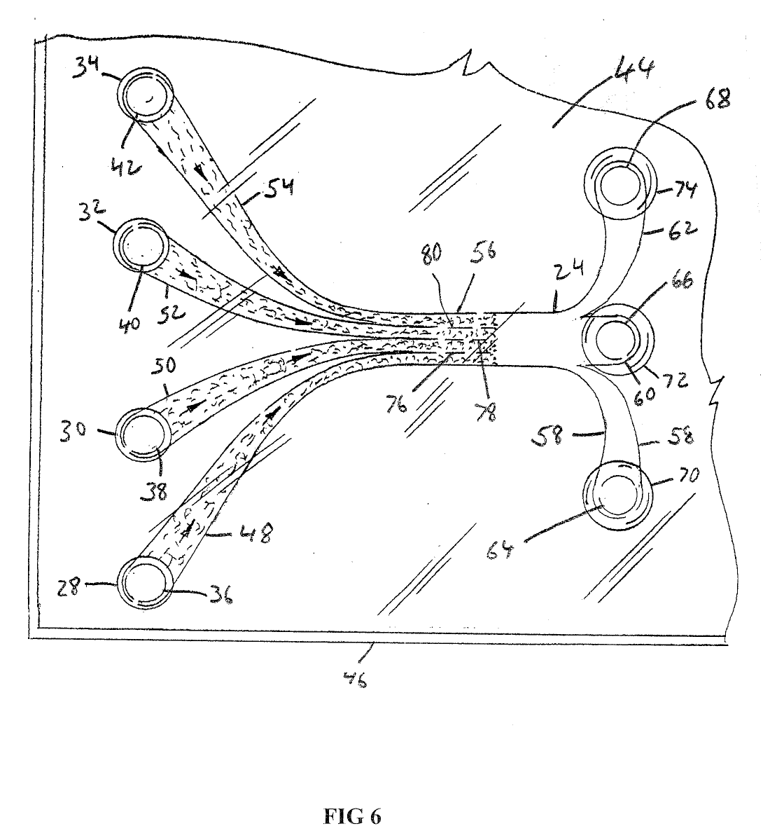

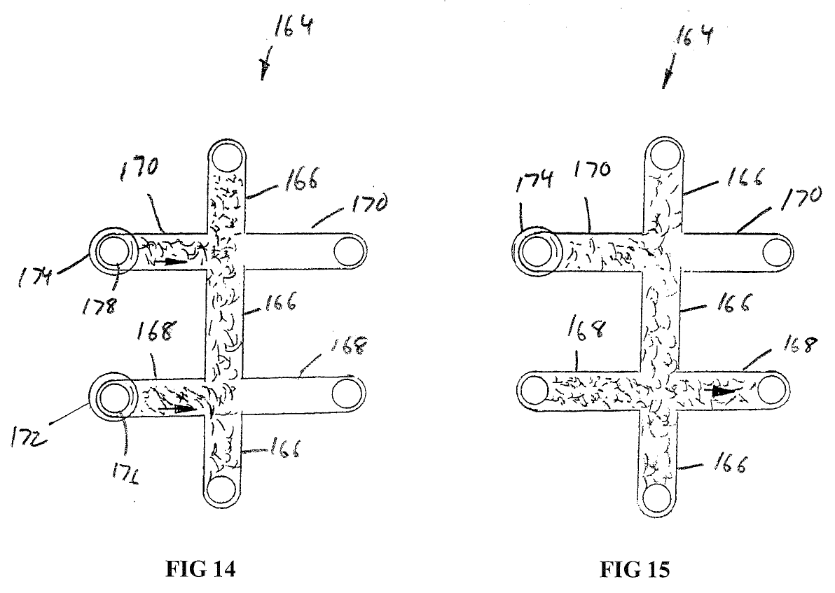

FIGS. 14 and 15 illustrate a reconstituted tissue device 164 including a microfluidic device where the test channel 166 can be separate from the readout channels 168 and 170. Readout drops 172, 174 are placed on corresponding readout inputs 176, 178 of channels 168 and 170. An example of a use of such a device is where test channel 166 undergoes electrophoresis, and the mobility of biomolecules is detected by readout channels 168, 170, particularly as shown in FIG. 15 where readout drop 174 has migrated into readout channel 170. At least some of the other characteristics of device 164 can be as previously described. Additionally, the characteristics of the embodiments of FIGS. 6-15 can be combined, alternated and varied as required by a particular application.

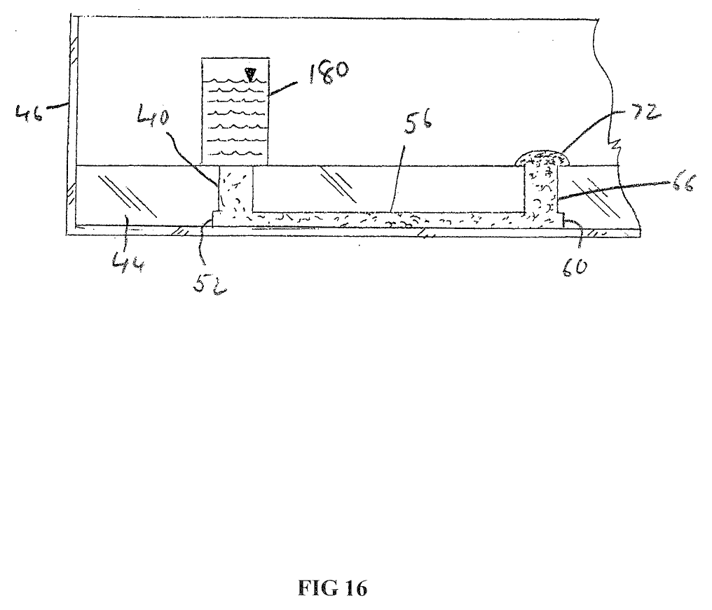

The use of passive pumping constantly applies a positive pressure on the various fluids as they flow in the microfluidic device. This applied positive pressure, along with the matching viscosity of the PEG and gel materials, and the design of the microfluidic device, allow the individual materials to flow in a predictable pattern and maintain the interfaces between the patterns. Disruption of the pressure on any of the channels can destroy the predictable pattern which is one reason why the passive pumping technique is advantageous for the present invention. However, other methods of applying pressure, for example, can be efficacious when combined with the matched viscosities and microfluidic devices according to the present invention. For example, and as shown in FIG. 16, a column 180 of water or other fluid can be used to produce a pressure head. Other potential sources of pressure head include a centrifugal pressure source, gyroscope pressure source, and a syringe pump, for example, among others.

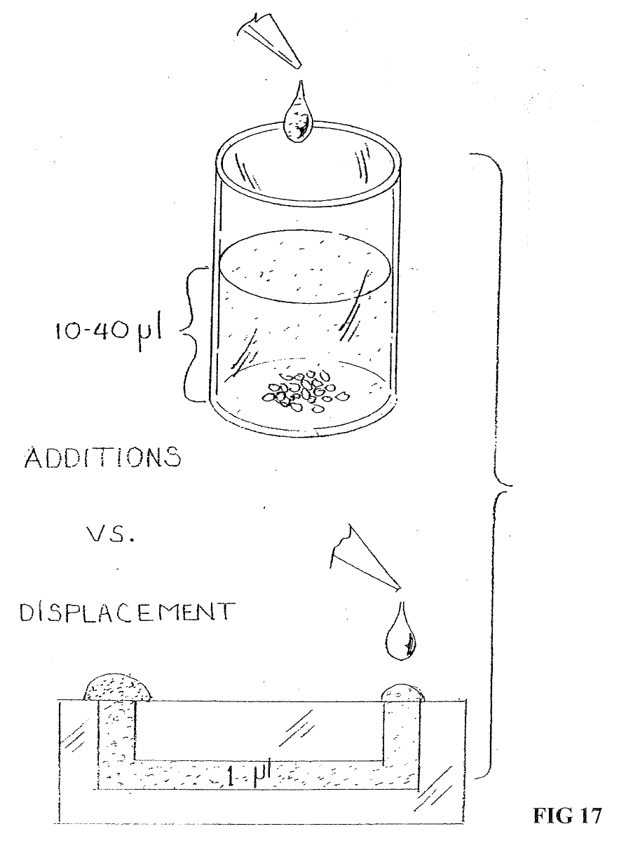

FIG. 17 illustrates some differences between an individual well of a multiwell plate versus a channel of microfluidic device according to the present invention, particularly illustrating the volume differences in the well (10-40 μl) and the microfluidic channel (1 μl), and also the lack of patterning and interfaces in the well device.

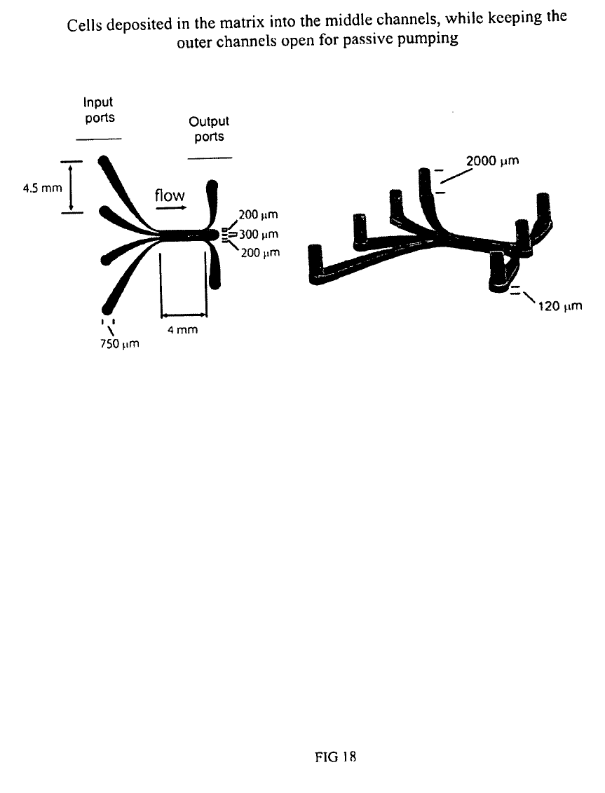

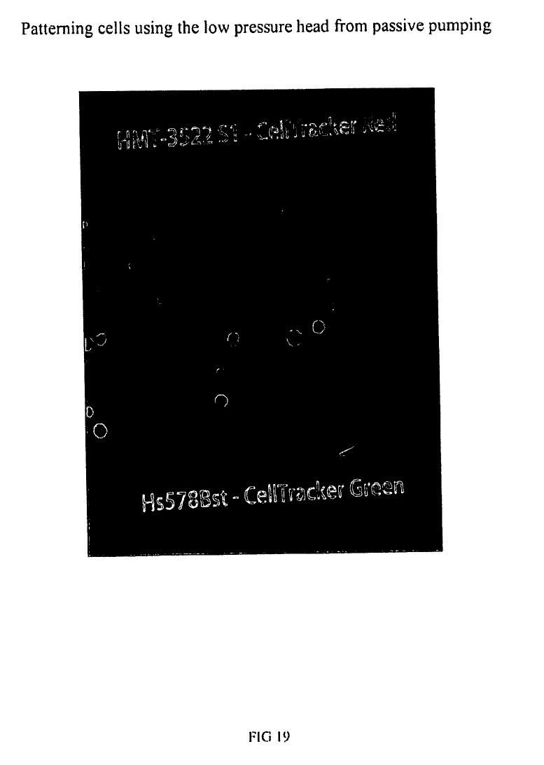

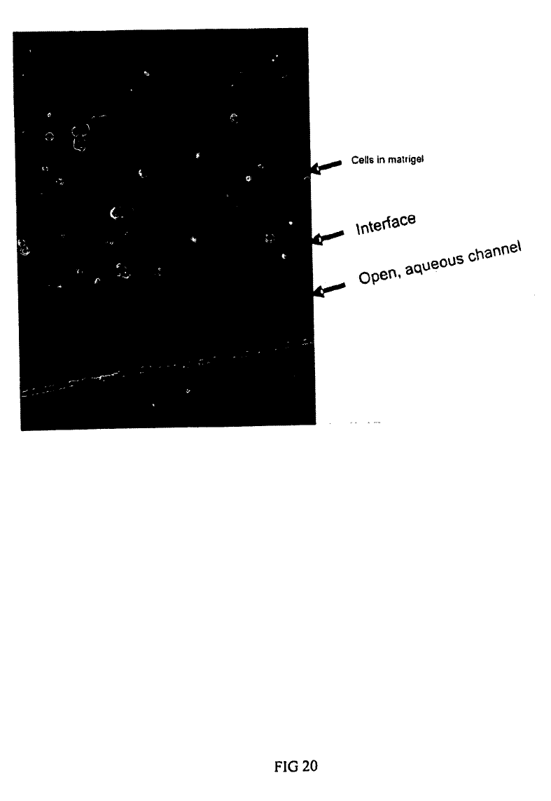

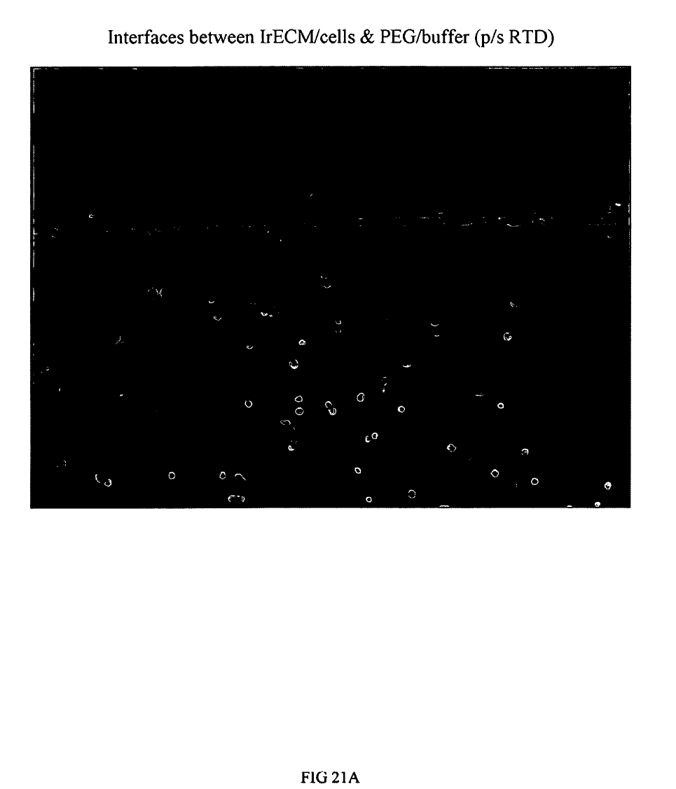

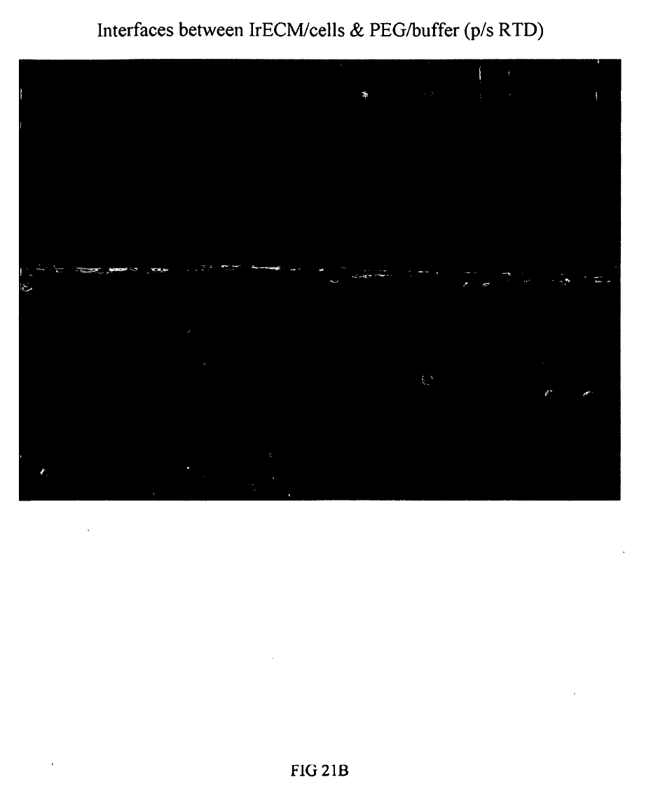

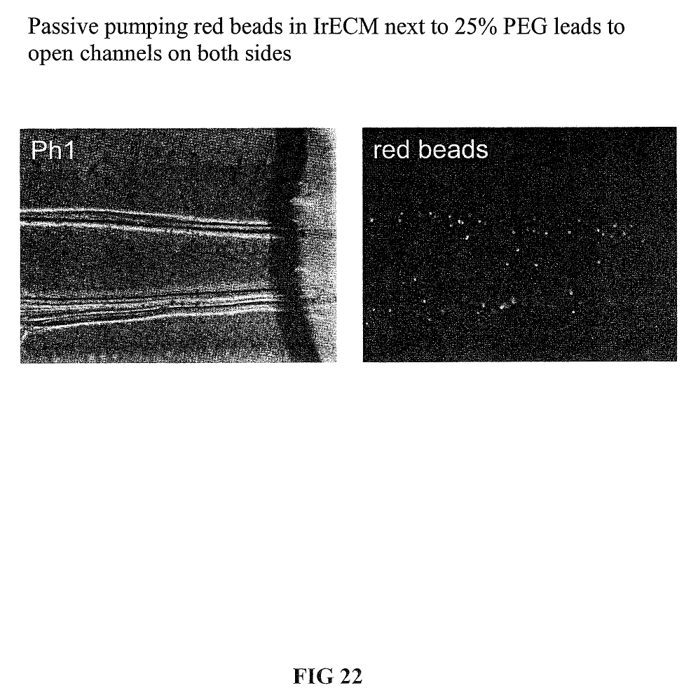

FIGS. 19-22 are various microphotographs of various views of reconstituted tissue devices created using the microfluidic device of FIG. 18, and the method according to the present invention.

The present invention can be applied to drug discovery, point of care diagnostics, bio-defense, biochemical, agricultural, immunology, molecular biology, molecular diagnostics, quality control, tissue culture, and synthetic chemistry/materials development, among others. Consequently, a wide variety of materials can be used for the initial fluid, viscosity matching fluid, gelatin material and corresponding suspended biological material (cells, proteins, stem cells, etc.), and reagents depending on the particular assay and application area.

The structure of the flow device including input/output (I/O) configurations, and the geometry of channels in plan view and cross-section, can be varied widely to achieve a particular patterning of material. For example, one material can be adjacent two or more materials by appropriate stacking and/or offset. As previously indicated, the gelatin/test composition material may vary for a given application, as can other aspects of the gels such as gel stimulation or conditions (UV irradiation, adding divalent elements, etc.), denaturing and renaturing of the gels, gelatin and matching fluid viscosity, time scale and temperature.

The readout/monitoring/detection method according to the present invention is highly suitable for automation, and in addition, requires little or no additional capital expense in order to implement. Readout drops can be applied with the same multichannel pipettor as is used to apply the test liquids, and the readout drops are visually indicated making them relatively easy to observe with a minimum or no intervening instruments. Further, the readout/monitoring/detection method according to the present invention can provide a change of status (1/0) indication, or can provide quantitative/qualitative information as is shown in FIGS. 14 and 15, where the change of status of readout drop 174 indicates the relative degree of mobility of the biomolecules.

The present invention consequently overcomes the previously mentioned limitations to miniaturization and automation of high throughput screening systems, with better replication of biological environments and improved readout/detection/monitoring capability.

Although at least some of the embodiments described above include passive pumping applied to a microfluidic device, and particularly an MCA, it is conceivable that the present invention can be accomplished in the presence of a magnetic field or other force field instead of a physical constraint such as a MCA, or another type of physical constraint, which force field or physical constraint sufficiently channels flow to maintain the individual structure (little or no mixing, relatively distinct interface) of separate gels.

A preferred embodiment of the invention has been described in considerable detail. Many modifications and variations to the preferred embodiment described will be apparent to a person of ordinary skill in the art. Therefore, the invention should not be limited to the embodiments described.

I/we claim:

1. A method for at least one of forming at least one gelatinous microstructure and detecting a decomposition of the at least one gelatinous microstructure.

2. The method of claim 1, comprising the steps of:
selecting a first material with a suspended biological material;
choosing a second material based on a correlation of a parameter of the second material with a parameter of the first material; and
predictably patterning said first material and said second material.

3. The method of claim 2, wherein said predictably patterning step includes gelation of said first material thereby creating at least one said gelatinous microstructure.

4. The method of claim 3, wherein said predictably patterning step is conducted in a microfluidic device.

5. The method of claim 3, further including the step of passively pumping a liquid into said first material.

6. The method of claim 5, further including the step of monitoring said liquid to determine a decomposition of the at least one said gelatinous microstructure.

7. A method for at least one of forming at least one gelatinous microstructure and detecting a decomposition of the at least one gelatinous microstructure, comprising the steps of:
selecting a first material with a suspended biological material;
choosing a second material based on a relationship of a parameter of the second material relative to a parameter of the first material; and
creating a first gentle pressure head at a first interface of said first material, and a second gentle pressure head at a second interface of said second material.

8. The method of claim 7, where in said first gentle pressure is approximately equal to said second gentle pressure.

9. The method of claim 7, further including the step of driving a flow of said first material and said second material thereby patterning said first material having said suspended biological material with said second material.

10. The method of claim 9, further including the step of stopping said flow by gelation of said first material.

11. The method of claim 10, wherein said gentle pressure head is less than a degradation pressure of one of said first material and said second material.

12. The method of claim 10, further including the step of maintaining said gelation of said first material.

13. The method of claim 12, further including the step of degrading said gelation.

14. The method of claim 13, wherein said degrading step occurs as a result of an interaction of a fluid of providing said first gentle pressure head.

15. The method of claim 7, further including the step of producing at least one of said first gentle pressure head and said second gentle pressure head by passive pumping.

16. The method of claim 7, further including the step of maintaining at least one of said first gentle pressure head and said second gentle pressure head by passive pumping.

17. A method of reconstituting a tissue device in a microfluidic device, comprising the steps of:
selecting a first material with a suspended biological material;
choosing a second material based on a correlation of a parameter of the second material with a parameter of the first material; and
predictably patterning said first material and said second material in the microfluidic device.

18. The method of claim 17, further including the step of maintaining a distinct interface between said first material and said second material.

19. The method of claim 17, further including the step of approximately matching said parameter of the second material with said parameter of the first material.

20. The method of claim 19, wherein said parameter of the second material is a viscosity of the second material, and said parameter of the first material is a viscosity of the first material.

21. A reconstituted tissue device fabricated with the method of claim 17.

22. A reconstituted tissue device, comprising:
a microfluidic device;
a first predictable pattern of a first material within said microfluidic device; and
a second predictable pattern of a second material within said microfluidic device.

23. The reconstituted tissue device of claim 22, further including an approximately distinct interface between the first predictable pattern and the second predictable pattern.

24. A method of self regulating a process of manufacturing a biological device, comprising the steps of:
choosing a first material and a second material based on a correlation of a parameter of the second material with a parameter of the first material; and
merging the first material with the second material where the correlation of the parameter of the second material with the parameter of the first material self regulates the merging step to provide a distinct patterning of the first material and the second material.

25. A microfluidic device for use in a high throughput screening system, comprising:
a central channel; and
a plurality of input channels in fluid communication with said central channel, where each of said plurality of input channels are gradually merged into a distinct region of said central channel.

26. A microconduit array use in a high throughput screening system, comprising:
a platform; and
a plurality of microfluidic devices formed in said platform, each of the plurality of microfluidic devices having a central channel, and a plurality of input channels in fluid communication with said central channel, where each of said plurality of input channels are gradually merged into a distinct region of said central channel.

27. A method of patterning a gel in a microfluidic device, the microfluidic device including a channel in fluid communication with a plurality of fluid inputs and at least one fluid output, said method comprising the steps of:
introducing an initial fluid into the channel of the microfluidic device;
depositing a reservoir drop of a corresponding reservoir fluid over each fluid output of the channel in sufficient dimension to overlap the corresponding output of the channel and to exert an output pressure on the initial fluid at the corresponding output of the channel;
applying a liquid gel to a first input of the channel, the gel being applied by depositing a first pumping drop of the liquid gel at the first input of the channel to exert a first input pressure on the initial fluid at the first input of the channel that is greater than the output pressure such that the first pumping drop flows into the channel through the first input;
applying a viscosity matching liquid to a second input of the channel, the viscosity matching liquid having approximately the same viscosity as the liquid gel, the viscosity matching liquid being applied by depositing a second pumping drop of the viscosity matching liquid at the second input of the channel to exert a second input pressure on the initial fluid at the a second input of the channel that is greater than the output pressure such that the second pumping drop flows into the channel through the second input;
simultaneously flowing the liquid gel and the viscosity matching liquid into the channel thereby displacing the initial fluid; and
gelatinizing the liquid gel into a solid gel.

28. The method of claim 27, further including the step of applying a second liquid gel to a third input of the channel, the second liquid gel being applied by depositing a pumping drop of the second liquid gel at the third input of the channel to exert a third input pressure on the initial fluid at the third input of the channel that is greater than the output pressure such that the pumping drop of the second liquid gel flows into the channel through the third input.

29. The method of claim 27, wherein the solid gel has a predictable pattern.

30. The method of claim 27, wherein the solid gel has a predictable interface.

31. The method of claim 27, further including the step of exhausting said another liquid from said channel.

32. The method of claim 27, further including the step of applying a reagent to the second input.

33. The method of claim 27, wherein the step of simultaneously flowing includes the substep of maintaining a pressure between the plurality of fluid inputs and the at least one fluid output.

34. The method of claim 27, wherein the viscosity matching liquid is polyethylene glycol.

35. A reconstituted tissue device fabricated with the method of claim 27.

36. A method of monitoring a gel in a microfluidic device, the microfluidic device including a channel in fluid communication with at least one fluid input and at least one fluid output, said method comprising the steps of:
creating a pattern of a material within the channel;
applying a detection drop at one input; and
monitoring the drop to determine if the drop flows.

37. The method of claim 36, wherein the detection drop is applied at same input as the material.

38. The method of claim 36, wherein the detection drop is applied at a different input than the material.

39. The method of claim 38, wherein the detection drop is applied at a multiple of different inputs other than the material input.

40. A reconstituted tissue device, comprising:
a microfluidic device including a channel;
a first patterning of a gel in the channel;
a second patterning of another gel adjacent the first patterning; and
an approximately distinct interface between the first patterning and the second patterning.

41. The reconstituted tissue device of claim 40, wherein both the first patterning and the second patterning are predictable.

42. The reconstituted tissue device of claim 40, wherein the reconstituted tissue device is fabricated using the method of claim 27.

43. A device for monitoring a status of a gel pattern, comprising
a device fabricated according to claim 40; and
a readout drop placed on at least one input of the channel.
